(19) United States
(12) Patent Application Publication
(10) Pub. No.: US 2026/0351007 A1
(43) Pub. Date: Nov. 5, 2026

(54) OPTIMIZATON SYSTEM FOR MAPPING PARKING SLOTS USING SIMULTANEOUS LOCALIZATION AND MAPPING

(71) Applicant: GM GLOBAL TECHNOLOGY OPERATIONS LLC, Detroit, MI (US)

(72) Inventors: Dan LEVI, Ganei Tikvah (IL); Jonathan Naor, Atlit (IL); Yotam Kramer, Hod Hasharon (IL); Matan Yeger, Pardes Hanna-Karkur (IL); Alex Cherniakov, Rehovot (IL); Peggy Lin, Etobicoke (CA)

(21) Appl. No.: 19/195,048

(22) Filed: Apr. 30, 2025

(51) Int. Cl. G06V 20/58; G06T 7/73

(52) U.S. Cl. CPC G06V 20/586; G06T 7/73

(57) ABSTRACT

A vision-based perception system for a vehicle includes N cameras that generate images. An image analysis module identifies features of parking slots in the images and generates keyframe measurements based thereon. A keyframe selecting module identifies selected ones of the keyframe measurements. A database receives the selected ones of the keyframe measurements and selectively outputs unassociated keyframe measurements and existing features of parking slots within a predetermined range of the vehicle. A data association module receives the unassociated keyframe measurements and the existing features of parking slots from the database and selectively associates selected ones of the keyframe measurements to existing features of parking slots and other selected ones of the keyframe measurements to new features of parking slots. An optimization module optimizes positions of the parking slots in a local map using a simultaneous localization and mapping (SLAM) cost function extended by at least one parking lot/slot factor.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vision-based perception systems, and more particularly to vision-based perception systems incorporating simultaneous localization and mapping.

Vehicles may include autonomous driving systems that operate the vehicle without driver input. The autonomous driving systems receive images from multiple cameras pointed in different directions. For example, the vehicle may include one or more forward facing cameras, one or more side facing cameras, and one or more rear facing cameras. Autonomous driving systems need to be able to sense the location of parking slots in a parking lot. The autonomous driving system may not know the locations of the parking slots in the parking lot before arriving at the parking lot and/or whether each of the parking slots are currently occupied. The autonomous driving system uses the images generated by the cameras while driving through the parking lot to determine the locations of available parking slots and then parks the vehicle in one of the available parking slots.

### SUMMARY

A vision-based perception system for a vehicle includes N cameras arranged on the vehicle and configured to generate a plurality of images, where N is an integer greater than one. An image analysis module is configured to identify a plurality of features of parking slots in the plurality of images and to generate a plurality of keyframe measurements based thereon. A keyframe selecting module is configured to identify selected ones of the plurality of keyframe measurements. A database is configured to receive the selected ones of the plurality of keyframe measurements and to selectively output unassociated keyframe measurements and existing features of parking slots within a predetermined range of the vehicle. A data association module is configured to receive the unassociated keyframe measurements and the existing features of parking slots from the database; and selectively associate selected ones of the keyframe measurements to existing features of parking slots and other selected ones of the keyframe measurements to new features of parking slots. An optimization module configured to optimize positions of the parking slots in a local map using a simultaneous localization and mapping (SLAM) cost function extended by at least one parking lot/slot factor.

In other features, at least two of the unassociated keyframe measurements and the existing features of the parking slots are a-synchronous measurements. The data association module is configured to generate measurements between the unassociated keyframe measurements and the existing features of the parking slots; identify inter-measurement associations; and identify inter-landmark associations.

In other features, the at least one parking lot/slot factor includes a quadrilateral factor evaluating keyframe measurements of a selected one of the parking slots relative to a quadrilateral. The at least one parking lot/slot factor includes a rectangular factor evaluating keyframe measurements of a selected one of the parking slots relative to a rectangle. The at least one parking lot/slot factor includes a line length factor evaluating equality of lengths of opposite sides of a selected one of the parking slots. The at least one parking lot/slot factor includes a parallel line factor evaluating parallelism of opposite sides of a selected one of the parking slots. The at least one parking lot/slot factor includes a neighbor size factor evaluating a size of a selected one of the parking slots relative to a size of a neighboring parking slot. The at least one parking lot/slot factor includes a neighbor co-parallel factor evaluating parallelism of a selected one of the parking slots relative to sides of a neighbor parking slot.

In other features, the at least one parking lot/slot factor includes a quadrilateral factor evaluating keyframe measurements of a selected one of the parking slots relative to a quadrilateral. The at least one parking lot/slot factor further includes two or more parking lot/slot factors selected from a group consisting of a line length factor evaluating equality of lengths of opposite sides of the selected one of the parking slots, a parallel line factor evaluating parallelism of opposite sides of the selected one of the parking slots, a rectangular factor evaluating keyframe measurements of the selected one of the parking slots relative to a rectangle, a neighbor size factor evaluating a size of the selected one of the parking slots relative to a size of a neighbor parking slot, and a neighbor co-parallel factor evaluating parallelism of the selected one of the parking slots relative to sides of a neighbor parking slot.

A vision-based perception system for a vehicle includes N cameras arranged on the vehicle and configured to generate a plurality of images, where N is an integer greater than one. An image analysis module is configured to identify a plurality of features of parking slots in the plurality of images and to generate a plurality of keyframe measurements based thereon. A keyframe selecting module is configured to identify selected ones of the plurality of keyframe measurements. A database is configured to receive the selected ones of the plurality of keyframe measurements and to selectively output unassociated keyframe measurements and existing features of parking slots within a predetermined range of the vehicle. A data association module is configured to receive the unassociated keyframe measurements and the existing features of the parking slots from the database; and selectively associate selected ones of the keyframe measurements to existing features of parking slots and other selected ones of the keyframe measurements to new features of the parking slots. An optimization module is configured to optimize positions of the parking slots using a simultaneous localization and mapping (SLAM) cost function including at least one parking lot/slot factor. The at least one parking lot/slot factor includes a quadrilateral factor evaluating keyframe measurements of a selected one of the parking slots to a quadrilateral. At least two of the unassociated keyframe measurements and the existing features of the parking slots are a-synchronous measurements.

In other features, the data association module is configured to generate measurements between the unassociated keyframe measurements and the existing features of the parking slots; identify inter-measurement associations; and identify inter-landmark associations.

In other features, the at least one parking lot/slot factor includes a rectangular factor evaluating keyframe measurements of the selected one of the parking slots relative to a rectangle. The at least one parking lot/slot factor includes a line length factor evaluating equality of lengths of opposite sides of the selected one of the parking slots. The at least one parking lot/slot factor includes a parallel line factor evaluating parallelism of opposite sides of the selected one of the parking slots. The at least one parking lot/slot factor includes a neighbor size factor evaluating a size of the selected one of the parking slots relative to a size of a neighbor parking slot. The at least one parking lot/slot factor includes a neighbor co-parallel factor evaluating parallelism of the selected one of the parking slots relative to sides of a neighboring parking slot. The at least one parking lot/slot factor includes one or more parking lot/slot factors selected from a group consisting of a line length factor evaluating equality of lengths of opposite sides of the selected one of the parking slots, a parallel line factor evaluating parallelism of opposite sides of the selected one of the parking slots, a rectangular factor evaluating keyframe measurements of the selected one of the parking slots relative to a rectangle, a neighbor size factor evaluating a size of the selected one of the parking slots relative to a size of a neighbor parking slot, and a neighbor co-parallel factor evaluating parallelism of the selected one of the parking slots relative to sides of a neighbor parking slot.

A vision-based perception system for a vehicle includes N cameras arranged on the vehicle and configured to generate a plurality of images, where N is an integer greater than one. An image analysis module is configured to identify a plurality of features of parking slots in the plurality of images and to generate a plurality of keyframe measurements based thereon. A keyframe selecting module is configured to identify selected ones of the plurality of keyframe measurements. A database is configured to receive the selected ones of the plurality of keyframe measurements and to selectively output unassociated keyframe measurements and existing features of parking slots within a predetermined range of the vehicle. A data association module is configured to receive the unassociated keyframe measurements and the existing features of the parking slots from the database; and selectively associate selected ones of the keyframe measurements to existing features of parking slots and other selected ones of the keyframe measurements to new features of the parking slots. An optimization module configured to optimize at least one of vehicle position and parking slot position using a simultaneous localization and mapping (SLAM) cost function including at least one parking lot/slot factor. The at least one parking lot/slot factor includes three or more parking lot/slot factors selected from a group consisting of a quadrilateral factor evaluating keyframe measurements of a selected one of the parking slots relative to a quadrilateral, a line length factor evaluating equality of lengths of opposite sides of the selected one of the parking slots, a parallel line factor evaluating parallelism of opposite sides of the selected one of the parking slots, a rectangular factor evaluation keyframe measurements of the selected one of the parking slots relative to a rectangle, a neighbor size factor evaluating a size of the selected one of the parking slots relative to a size of a neighbor parking slot, and a neighbor co-parallel factor evaluating parallelism of the selected one of the parking slots relative to sides of a neighbor parking slot.

In other features, at least two of the unassociated keyframe measurements and the existing features of the parking slots are a-synchronous measurements.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a vision-based system configured to map and localize parking slots in a parking lot according to the present disclosure;

FIG. 2A is a plan view of an example of a vehicle passing through a parking lot with parking slots and parking in one of the parking slots according to the present disclosure;

FIG. 2B illustrates a vehicle in a parking slot according to the present disclosure;

FIG. 3 is a functional block diagram of an example of an optimization module using a simultaneous localization and mapping (SLAM) cost function including parking slot/lot related extensions to optimize a local map according to the present disclosure;

FIG. 4 is an example of graph-based simultaneous localization and mapping for parking slots in a parking lot according to the present disclosure; and

FIG. 5 is a functional block diagram of the optimization module of the SLAM with a simultaneous localization and mapping (SLAM) cost function extended by one or more parking lot/slot related factors according to the present disclosure.

In the drawings, reference numbers may be reused to identify similar and/or identical elements.

### DETAILED DESCRIPTION

Parking slots are large, static, flat objects with a robust and consistent structure. Utilizing extension factors relating to the parking lot/slots during simultaneous localization and mapping (SLAM) reduces cumulative localization errors by providing fixed, robust landmarks. Enforcing prior constraints in a simultaneous localization and mapping (SLAM) cost function (e.g., a quadrilateral shape and parallelism) improves data association, minimizes false matches, and/or enhances mapping consistency. Leveraging inter-slot geometric relations allow for out-of-view elements to contribute, which further counters odometry measurement noise and detection uncertainty.

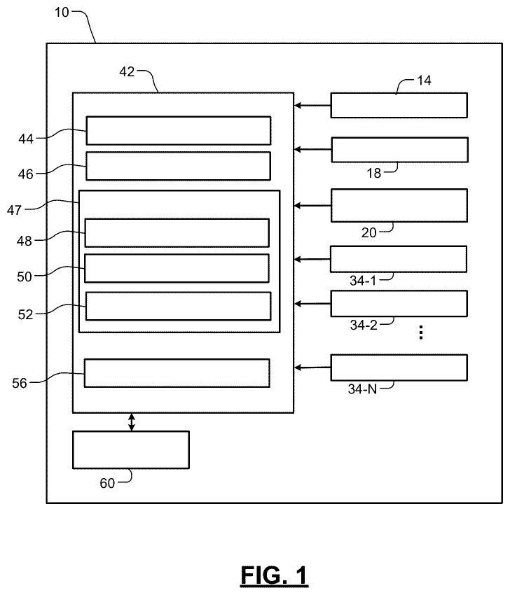

Referring now to FIG. 1, a vehicle 10 includes various sensors such as a global positioning system (GPS) 14, an inertial measurement unit (IMU) 18, and wheel speed sensors 20. The vehicle 10 includes one or more cameras 34-1, 34-2, . . . , and 34-N that generate images in forward, side, and rear directions relative to the vehicle 10, wherein N is an integer greater than one. In some examples, the cameras 34-1, 34-2, . . . , and 34-N include one or more forward-facing cameras, one or more side-facing cameras, and one or more rear-facing cameras.

A controller 42 includes an image analysis module 44 configured to receive the images from the cameras 34-1, 34-2, . . . , and 34-N, identify landmarks or parking slot features (e.g., corners or centers of parking slots) in the images, and generate keyframe measurements from the corresponding camera to the landmarks in the images. In some examples, the keyframe measurements include corners or centers of parking slots. In some examples, the image analysis module 44 may include a neural network configured to identify various objects such as centers or corners of parking slots.

A keyframe selecting module 46 selects keyframe measurements (each with a timestamp) from the images. The cameras 34-1, 34-2, . . . , and 34-N generate a lot of samples and not all of the samples provide new or useful information. For example, the measurements may or may not change significantly in subsequent keyframes during sequential timestamps when the vehicle is stationary or travelling slowly. Not all of the images will include parking slots. The keyframe selecting module 46 is configured to select some or all of the keyframes depending upon the value of the data.

A simultaneous localization and mapping (SLAM) module 47 is configured to perform localization and mapping. In some examples, the SLAM module 47 includes a graph-based SLAM. In some examples, the SLAM module 47 includes Georgia Tech smoothing and mapping (GTSAM) module or g2o module, although other types of optimization modules can be used.

The SLAM module 47 includes a data association module 48 that is configured to receive keyframes and to associate the keyframes with either existing states (e.g., parking slots that were already identified) or new states (e.g., new parking slots that were not previously identified). Additional details relating to the data association module 48 can be found in U.S. patent application Ser. No. 19/194,253 (Attorney Docket No. P110843), entitled “A-Synchronous Association for Parking Slot Measurements”, which is hereby incorporated by reference in its entirety.

In some examples, the SLAM module 47 includes an optimization module 52 that manages and optimizes SLAM states. In some examples, the SLAM states correspond to vehicle and/or camera locations and parking slot features (such as corners or centers of parking slots).

In some examples, the SLAM module 47 includes further includes a scale estimating module 50 configured to estimate a scale of measurements on a per camera and/or per measurement basis. Additional details relating to the scale estimating module 50 can be found in U.S. patent application Ser. No. 19/194,338 (Attorney Docket No. P110844), entitled “Incremental Scale Estimation for Vision-Based Autonomous Driving Systems”, which is hereby incorporated by reference in its entirety.

The controller 42 includes an autonomous driving module 56 configured to control actuators 60 such as steering, braking, and/or acceleration of the vehicle 10. For example, the autonomous driving module 56 may park the vehicle in one of the parking slots identified and mapped by the parking slot location module 54.

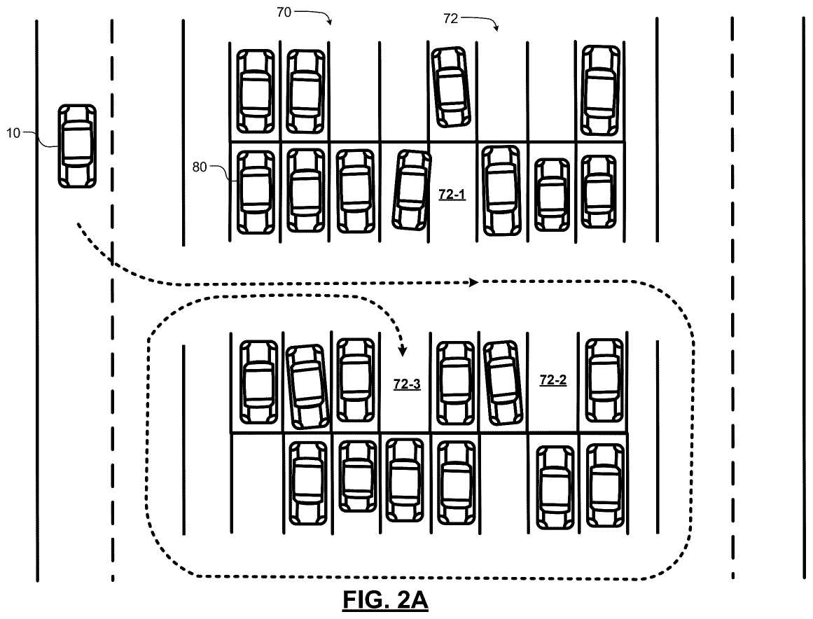

Referring now to FIG. 2A, the vehicle 10 enters a parking lot 70 including plurality of parking slots 72. The vehicle 10 generates images using the cameras 34-1, 34-2, . . . , and 34-N. Some of the images are selected as keyframes. Some of the selected keyframes may include parking slots that are identified by parking slot features such as centers or corner locations. The keyframes include locations of the corners of one or more parking slots at a given timestamp. In some examples, the keyframes are generated by one camera (such as parking slots located on one side of the vehicle 10). In some examples, the keyframes for a given timestamp can be generated by cameras on both sides of the vehicle, the front camera, and/or the rear camera.

Some of the parking slots 72 are occupied by vehicles 80 and others of the parking slots 72 are open. The vehicle 10 may proceed directly to one of the parking slots 72 such as parking slot 72-1 or parking slot 72-2 or the vehicle 10 may drive around the parking lot 70 before selecting one of the parking slots such as parking slot 72-3.

Referring now to FIG. 2B, an example of a parking slot including corners 1, 2, 3, and 4 is shown. In some examples, the locations of the near corners 2, 3 may be detected (with high confidence and low covariance) and the far corners 1, 4 may be estimated (with lower confidence and higher covariance) due to the position of the vehicle being closer to corners 2, 3.

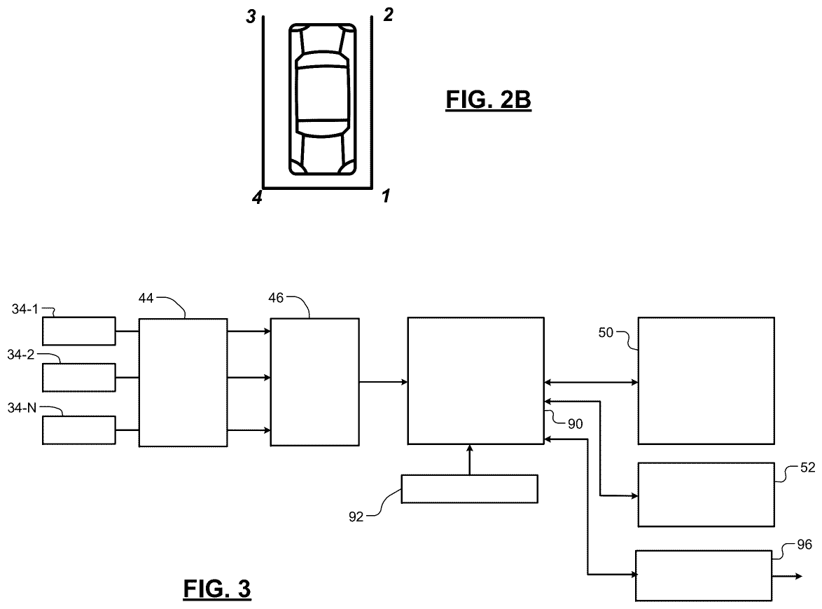

Referring now to FIG. 3, the cameras 34-1, 34-2, . . . , and 34-N output images to the image analysis module 44. The image analysis module 44 outputs keyframes to a keyframe selection module 46 that selects some of the keyframes for further analysis. The selected keyframes are stored in a database 90, such as a structured query language (SQL) database, along with odometry/IMU data 92 corresponding to the timestamps of the keyframe measurements.

A data association module 74 is configured to determine whether unassociated keyframe measurements (e.g., parking slot features such as centers of corner locations of parking slots) correspond to existing parking slots that were previously detected or new parking slots. In some examples, the data association module 74 makes measurements between unassociated keyframe measurements (e.g., parking slots in the keyframes that have not been associated) and locations of existing parking slots. In some examples, the data association module 74 identifies inter-measurement associations. In some examples, the data association module 74 identifies inter-landmark associations. Additional details relating to the data association module 48 can be found in U.S. patent application Ser. No. 19/194,253 (Attorney Docket No. P110843), entitled “A-Synchronous Association for Parking Slot Measurements”.

The optimization module 52 optimizes the SLAM states and the local map using a simultaneous localization and mapping (SLAM) cost function that is extended by the one or more parking slot/lot related factors as will be described further below. A map publisher 96 retrieves data from the database 90 and generates and publishes a local map in a sliding window around the vehicle. In some examples, the autonomous driving module 56 uses the local map to select a parking slot and to park the vehicle in the parking slot.

Referring now to FIG. 4, a graph-based map generated during SLAM is shown for a vehicle and parking slots in a parking lot. In the graph, the vehicle moves from vehicle states x₀ to x₁, x₁ to x₂, and x₂ to x₃. In each of the vehicle states, the cameras of the vehicle perceive landmarks l₀ and l₁ corresponding to parking slots.

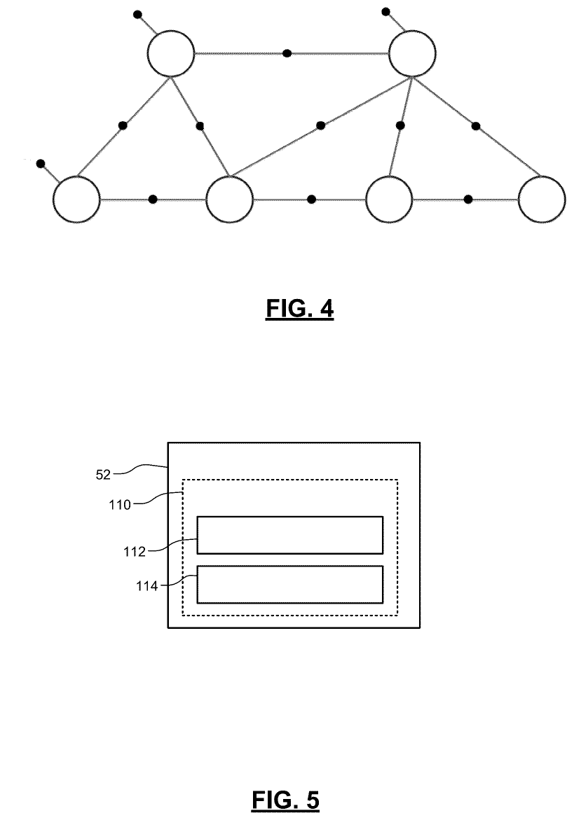

Referring now to FIG. 5, the optimization module 52 is extended by adjusting a simultaneous localization and mapping (SLAM) cost function 110 to include other factors such as parking lot/slot factors 112. The SLAM cost function may also include other typical SLAM factors 114. Examples of parking lot/slot factors 112 include a quadrilateral factor, a line length factor, a parallel line factor, a rectangular factor, a neighbor size factor, and a neighbor co-parallel factor. As a particular attribute of the parking slot or parking lot varies from what is expected, the SLAM cost function associated with the corresponding parking slot factor increases. The optimization module 52 attempts to minimize the SLAM cost function by iterating and varying the estimated location of the parking slot and reevaluating the SLAM cost function.

The quadrilateral factor is a SLAM cost function component that evaluates whether or not the parking slot shape is a quadrilateral (since most parking slots are quadrilaterals). The quadrilateral factor compares the keyframe measurements with 3D locations the four corners of a parking slot. In some examples, the comparison is measured in center of gravity (CG) coordinates. In other words, the SLAM cost function receives the keyframe measurements of the parking slot corners and the quadrilateral representing the parking slot in global coordinates and uses the parking slot measurement to align these states.

The line length factor is a SLAM cost function component that evaluates whether opposite sides of the parking slot (e.g., 3-4 and 1-2) are equal in length (since most opposite lines of parking slots have equal length). In other words, the line length factor forces opposite sides 1-2 and 3-4 of the parking slot to be equal in length:

ζ₁=∥X₂−X₁∥−∥X₃−X₄∥={square root over (x₂−x₁)²+(y₂−y₁)²+(z₂−z₁)²)}+{square root over (x₃−x₄)²+(y₃−y₄)²+(z₃−z₄)²)}=0

ζ₂=∥X₄−X₁∥−∥X₃−X₂∥={square root over (x₄−x₁)³+(y₄−y₁)²+(z₄−z₁)²)}+{square root over (x₃−x₂)²+(y₃−y₂)²+(z₃−z₂)²)}=0

The parallel line factor is a SLAM cost function component that evaluates whether opposite sides of the parking slots are parallel (e.g., 3-4 is parallel to 1-2) (since most parking slots are generally parallel).

$${ξ}_{3} = ( {X}_{2} - {X}_{1} ) \times ( {X}_{3} - {X}_{4} ) = [ \begin{matrix}0 \\ 0 \\ 0\end{matrix} ]$$

$${ξ}_{4} = ( {X}_{4} - {X}_{1} ) \times ( {X}_{3} - {X}_{2} ) = [ \begin{matrix}0 \\ 0 \\ 0\end{matrix} ]$$

### Jacobians:

$$\frac{\partial {ζ}_{1}}{\partial {X}_{1}} = \frac{{X}_{1} - {X}_{2}}{‖ {X}_{2} - {X}_{1} ‖} , \frac{\partial {ζ}_{1}}{\partial {X}_{2}} = \frac{{X}_{2} - {X}_{1}}{‖ {X}_{2} - {X}_{1} ‖} ,$$

$$\frac{\partial {ζ}_{1}}{\partial {X}_{3}} = \frac{{X}_{4} - {X}_{3}}{‖ {X}_{4} - {X}_{3} ‖} , \frac{\partial {ζ}_{1}}{\partial {X}_{4}} = \frac{{X}_{3} - {X}_{4}}{‖ {X}_{4} - {X}_{3} ‖}$$

$$\frac{\partial {ζ}_{2}}{\partial {X}_{1}} = \frac{{X}_{1} - {X}_{4}}{‖ {X}_{4} - {X}_{1} ‖} , \frac{\partial {ζ}_{2}}{\partial {X}_{2}} = \frac{{X}_{3} - {X}_{2}}{‖ {X}_{3} - {X}_{2} ‖}$$

$$\frac{\partial {ζ}_{2}}{\partial {X}_{3}} = \frac{{X}_{2} - {X}_{3}}{‖ {X}_{3} - {X}_{2} ‖} , \frac{\partial {ζ}_{2}}{\partial {X}_{4}} = \frac{{X}_{4} - {X}_{1}}{‖ {X}_{4} - {X}_{1} ‖}$$

$$\frac{\partial {ζ}_{3}}{\partial {X}_{1}} = {[ {X}_{3} - {X}_{4} ]}_{\times } , \frac{\partial {ζ}_{3}}{\partial {X}_{2}} = {[ {X}_{4} - {X}_{3} ]}_{\times }$$

$$\frac{\partial {ζ}_{3}}{\partial {X}_{3}} = {[ {X}_{2} - {X}_{1} ]}_{\times } , \frac{\partial {ζ}_{3}}{\partial {X}_{4}} = {[ {X}_{1} - {X}_{2} ]}_{\times }$$

$$\frac{\partial {ζ}_{4}}{\partial {X}_{1}} = {[ {X}_{3} - {X}_{2} ]}_{\times } , \frac{\partial {ζ}_{4}}{\partial {X}_{2}} = {[ {X}_{1} - {X}_{4} ]}_{\times } ,$$

$$\frac{\partial {ζ}_{4}}{\partial {X}_{3}} = {[ {X}_{4} - {X}_{1} ]}_{\times } , \frac{\partial {ζ}_{4}}{\partial {X}_{4}} = {[ {X}_{2} - {X}_{3} ]}_{\times }$$

### Covariance:

$$diag ( {noise}_{8 \times 8} ) = [ \begin{matrix}length diff between L 12 and L {34}_{[ m ]} \\ length diff between L 23 and L {14}_{[ m ]} \\ ‖ L 21 ‖ \cdot ‖ L 34 ‖ \cdot sin ( Δ {α}_{21 - 34} ) \cdot {n}_{x} \\ ‖ L 21 ‖ \cdot ‖ L 34 ‖ \cdot sin ( Δ {α}_{21 - 34} ) \cdot {n}_{y} \\ ‖ L 21 ‖ \cdot ‖ L 34 ‖ \cdot sin ( Δ {α}_{21 - 34} ) \cdot {n}_{z} \\ ‖ L 41 ‖ \cdot ‖ L 32 ‖ \cdot sin ( Δ {α}_{41 - 32} ) \cdot {n}_{x} \\ ‖ L 41 ‖ \cdot ‖ L 32 ‖ \cdot sin ( Δ {α}_{41 - 32} ) \cdot {n}_{y} \\ ‖ L 41 ‖ \cdot ‖ L 32 ‖ \cdot sin ( Δ {α}_{41 - 32} ) \cdot {n}_{z}\end{matrix} ]$$

The rectangular factor determines whether the parking slot is a rectangle. A rectangle is a parallelogram with sides forming a right angle.

$${ζ}_{1} = {p}_{1} - {p}_{2} + {p}_{3} - {p}_{4} = [ \begin{matrix}0 \\ 0 \\ 0\end{matrix} ]$$

$${ζ}_{2} = {( {p}_{2} - {p}_{1} )}^{T} \cdot ( {p}_{4} - {p}_{1} ) = 0$$

### Jacobian:

$$\frac{\partial {ζ}_{1}}{\partial {p}_{1}} = {I}_{3} , \frac{\partial {ζ}_{1}}{\partial {p}_{2}} = - {I}_{3} , \frac{\partial {ζ}_{1}}{\partial {p}_{3}} = {I}_{3} , \frac{\partial {ζ}_{1}}{\partial {p}_{4}} = - {I}_{3}$$

$$\frac{\partial {ζ}_{2}}{\partial {p}_{1}} = 2 \cdot {p}_{1} - {p}_{2} - {p}_{4} , \frac{\partial {ζ}_{2}}{\partial {p}_{2}} = {p}_{4} - {p}_{1} , \frac{\partial {ζ}_{2}}{\partial {p}_{3}} = 0 , \frac{\partial {ζ}_{2}}{\partial {p}_{4}} = {p}_{2} - {p}_{1}$$

The neighbor size factor is a SLAM cost function component that evaluates whether neighboring slots have similar dimensions (since most parking slots have a uniform shape in a given parking lot or within a given sliding window). If there is an inter-parking slot area, the inter-parking slot area is also constrained to be a parallelogram. The neighbor co-parallel factor is a SLAM cost function component that evaluates whether neighboring slots are co-parallel (since most parking lots have parking slots that are aligned).

Extending the optimization module of the SLAM with a cost function optimizing parking lot/slot factors significantly improves the accuracy of the local map.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curd, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vision-based perception system for a vehicle, comprising:
N cameras arranged on the vehicle and configured to generate a plurality of images, where N is an integer greater than one;
an image analysis module configured to identify a plurality of features of parking slots in the plurality of images and to generate a plurality of keyframe measurements based thereon;
a keyframe selecting module configured to identify selected ones of the plurality of keyframe measurements;
a database configured to receive the selected ones of the plurality of keyframe measurements and to selectively output unassociated keyframe measurements and existing features of parking slots within a predetermined range of the vehicle; and
a data association module configured to:
receive the unassociated keyframe measurements and the existing features of parking slots from the database; and
selectively associate selected ones of the keyframe measurements to existing features of parking slots and other selected ones of the keyframe measurements to new features of parking slots; and
an optimization module configured to optimize positions of the parking slots in a local map using a simultaneous localization and mapping (SLAM) cost function extended by at least one parking lot/slot factor.

2. The vision-based perception system of claim 1, wherein at least two of the unassociated keyframe measurements and the existing features of the parking slots are a-synchronous measurements.

3. The vision-based perception system of claim 1, wherein the data association module is configured to:
generate measurements between the unassociated keyframe measurements and the existing features of the parking slots;
identify inter-measurement associations; and
identify inter-landmark associations.

4. The vision-based perception system of claim 1, wherein the at least one parking lot/slot factor includes a quadrilateral factor evaluating keyframe measurements of a selected one of the parking slots relative to a quadrilateral.

5. The vision-based perception system of claim 1, wherein the at least one parking lot/slot factor includes a rectangular factor evaluating keyframe measurements of a selected one of the parking slots relative to a rectangle.

6. The vision-based perception system of claim 1, wherein the at least one parking lot/slot factor includes a line length factor evaluating equality of lengths of opposite sides of a selected one of the parking slots.

7. The vision-based perception system of claim 1, wherein the at least one parking lot/slot factor includes a parallel line factor evaluating parallelism of opposite sides of a selected one of the parking slots.

8. The vision-based perception system of claim 1, wherein the at least one parking lot/slot factor includes a neighbor size factor evaluating a size of a selected one of the parking slots relative to a size of a neighboring parking slot.

9. The vision-based perception system of claim 1, wherein the at least one parking lot/slot factor includes a neighbor co-parallel factor evaluating parallelism of a selected one of the parking slots relative to sides of a neighbor parking slot.

10. The vision-based perception system of claim 1, wherein:
the at least one parking lot/slot factor includes a quadrilateral factor evaluating keyframe measurements of a selected one of the parking slots relative to a quadrilateral; and
the at least one parking lot/slot factor further includes two or more parking lot/slot factors selected from a group consisting of:
a line length factor evaluating equality of lengths of opposite sides of the selected one of the parking slots,
a parallel line factor evaluating parallelism of opposite sides of the selected one of the parking slots,
a rectangular factor evaluating keyframe measurements of the selected one of the parking slots relative to a rectangle,
a neighbor size factor evaluating a size of the selected one of the parking slots relative to a size of a neighbor parking slot, and
a neighbor co-parallel factor evaluating parallelism of the selected one of the parking slots relative to sides of a neighbor parking slot.

11. A vision-based perception system for a vehicle, comprising:
N cameras arranged on the vehicle and configured to generate a plurality of images, where N is an integer greater than one;
an image analysis module configured to identify a plurality of features of parking slots in the plurality of images and to generate a plurality of keyframe measurements based thereon;
a keyframe selecting module configured to identify selected ones of the plurality of keyframe measurements;
a database configured to receive the selected ones of the plurality of keyframe measurements and to selectively output unassociated keyframe measurements and existing features of parking slots within a predetermined range of the vehicle; and
a data association module configured to:
receive the unassociated keyframe measurements and the existing features of the parking slots from the database; and
selectively associate selected ones of the keyframe measurements to existing features of parking slots and other selected ones of the keyframe measurements to new features of the parking slots; and
an optimization module configured to optimize positions of the parking slots using a simultaneous localization and mapping (SLAM) cost function including at least one parking lot/slot factor,
wherein the at least one parking lot/slot factor includes a quadrilateral factor evaluating keyframe measurements of a selected one of the parking slots to a quadrilateral, and
wherein at least two of the unassociated keyframe measurements and the existing features of the parking slots are a-synchronous measurements.

12. The vision-based perception system of claim 11, wherein the data association module is configured to:
generate measurements between the unassociated keyframe measurements and the existing features of the parking slots;
identify inter-measurement associations; and
identify inter-landmark associations.

13. The vision-based perception system of claim 11, wherein the at least one parking lot/slot factor includes a rectangular factor evaluating keyframe measurements of the selected one of the parking slots relative to a rectangle.

14. The vision-based perception system of claim 11, wherein the at least one parking lot/slot factor includes a line length factor evaluating equality of lengths of opposite sides of the selected one of the parking slots.

15. The vision-based perception system of claim 11, wherein the at least one parking lot/slot factor includes a parallel line factor evaluating parallelism of opposite sides of the selected one of the parking slots.

16. The vision-based perception system of claim 11, wherein the at least one parking lot/slot factor includes a neighbor size factor evaluating a size of the selected one of the parking slots relative to a size of a neighbor parking slot.

17. The vision-based perception system of claim 11, wherein the at least one parking lot/slot factor includes a neighbor co-parallel factor evaluating parallelism of the selected one of the parking slots relative to sides of a neighboring parking slot.

18. The vision-based perception system of claim 1, wherein the at least one parking lot/slot factor includes one or more parking lot/slot factors selected from a group consisting of:
a line length factor evaluating equality of lengths of opposite sides of the selected one of the parking slots,
a parallel line factor evaluating parallelism of opposite sides of the selected one of the parking slots,
a rectangular factor evaluating keyframe measurements of the selected one of the parking slots relative to a rectangle,
a neighbor size factor evaluating a size of the selected one of the parking slots relative to a size of a neighbor parking slot, and
a neighbor co-parallel factor evaluating parallelism of the selected one of the parking slots relative to sides of a neighbor parking slot.

19. A vision-based perception system for a vehicle, comprising:
N cameras arranged on the vehicle and configured to generate a plurality of images, where N is an integer greater than one;
an image analysis module configured to identify a plurality of features of parking slots in the plurality of images and to generate a plurality of keyframe measurements based thereon;
a keyframe selecting module configured to identify selected ones of the plurality of keyframe measurements;
a database configured to receive the selected ones of the plurality of keyframe measurements and to selectively output unassociated keyframe measurements and existing features of parking slots within a predetermined range of the vehicle; and
a data association module configured to:
receive the unassociated keyframe measurements and the existing features of the parking slots from the database; and
selectively associate selected ones of the keyframe measurements to existing features of parking slots and other selected ones of the keyframe measurements to new features of the parking slots; and
an optimization module configured to optimize at least one of vehicle position and parking slot position using a simultaneous localization and mapping (SLAM) cost function including at least one parking lot/slot factor,
wherein the at least one parking lot/slot factor includes three or more parking lot/slot factors selected from a group consisting of:
a quadrilateral factor evaluating keyframe measurements of a selected one of the parking slots relative to a quadrilateral,
a line length factor evaluating equality of lengths of opposite sides of the selected one of the parking slots,
a parallel line factor evaluating parallelism of opposite sides of the selected one of the parking slots,
a rectangular factor evaluation keyframe measurements of the selected one of the parking slots relative to a rectangle,
a neighbor size factor evaluating a size of the selected one of the parking slots relative to a size of a neighbor parking slot, and
a neighbor co-parallel factor evaluating parallelism of the selected one of the parking slots relative to sides of a neighbor parking slot.

20. The vision-based perception system of claim 19, wherein at least two of the unassociated keyframe measurements and the existing features of the parking slots are a-synchronous measurements.
